(19) United States
(12) Patent Application Publication
(10) Pub. No.: US 2009/0143094 A1
(43) Pub. Date: Jun. 4, 2009

(54) Method and Apparatus for Mode Switching in Dual-Core Mobile Communication Devices

(75) Inventors: Ian Shen, Nanjing (CN); Hailan Li, Boca Raton, FL (US)

Correspondence Address: LEVEQUE INTELLECTUAL PROPERTY LAW, P.C., 221 EAST CHURCH ST., FREDERICK, MD, 21701, US

(73) Assignee: Motorola, Inc., Schaumburg, IL (US)

(21) Appl. No.: 11/949,468

(22) Filed: Dec. 3, 2007

(51) Int. Cl. H04M 1/00

(52) U.S. Cl. 455/550.1

(57) ABSTRACT

A mobile communication device. The mobile communication device includes a baseband processor and an application processor. The application processor includes a modem proxy service module communicatively coupled to the baseband processor and an application management service module communicatively coupled to the modem proxy service module and configured to retrieve identification of a new operating mode. The application management service module is configured to direct appropriate components to initiate actions necessary to switch to the new mode, convey a request to the baseband processor to switch to the new mode, and switch the application processor to the new mode. The baseband processor is configured to convey notification to the application management service module that it completed the mode switch. The application management service module is further configured to update a current mode identification to be the new mode identification and notify all appropriate components that the mode switch has been completed.

### BACKGROUND

Modern mobile telephones often have the ability to operate in various different types of operational modes. Such operational mode types can include subscriber mode, airplane mode, test mode, flash mode, and others. The subscriber mode is the most common and is used to obtain full calling and receiving service for the mobile telephone. The airplane mode is used in certain critical areas, such as in airplanes, when it is necessary to operate with radio frequency (RF) emissions from the mobile telephone turned off but when the user wishes to exercise other functions available on the mobile telephone. Various test modes can be used during fabrication, as well as after, for confirmation of product quality and for the identification and diagnosis of operational problems. And, the flash mode is used to update the mobile telephone's software by reprogramming, i.e., flashing, the mobile telephone's firmware.

It may be necessary during the operation of a mobile telephone to switch from one operational mode to another. If this situation occurs, certain rules must be followed in order for the telephone to switch smoothly from the current mode to the new mode. Switching from one mode to another could be accomplished relatively easily for legacy single core mobile telephones by simply turning the power off to the telephone and then turning it back on.

More and more mobile telephones are migrating to a dual-core structure for better performance and higher efficiency. Modern dual-core mobile telephones use an application processor (AP) and a baseband processor (BP) each of which has a separate operational mode at any given time. Thus, switching operational modes in a dual-core mobile telephone can involve switching the operational mode of one or both of these processors. Simply power-cycling the dual-core, mobile telephone in order to change operation modes now can involve longer time delays due to its more complicated architecture, larger software size, and longer power-cycle time.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. In these drawings, like reference numerals identify corresponding elements.

FIG. 1 is a block diagram of a mobile communication device having dual-cores as described in various representative embodiments.

FIG. 2 is a flow chart of a method for mode switching during a power-cycle operation of the mobile communication device of FIG. 1.

FIG. 3 is a flow chart of a method for mode switching during normal operation of the mobile communication device of FIG. 1.

### DETAILED DESCRIPTION

As shown in the drawings for purposes of illustration, novel techniques are disclosed herein for mode switching in dual-core mobile communication devices. Previously mode switching in mobile communication devices has been accomplished by turning the power off to the mobile communication device and then turning it back on. While this technique has been generally acceptable to the users of legacy mobile telephones, which are single-core, it is unacceptably slow for the newer dual-core mobile telephones.

In the following detailed description and in the several figures of the drawings, like elements are identified with like reference numerals.

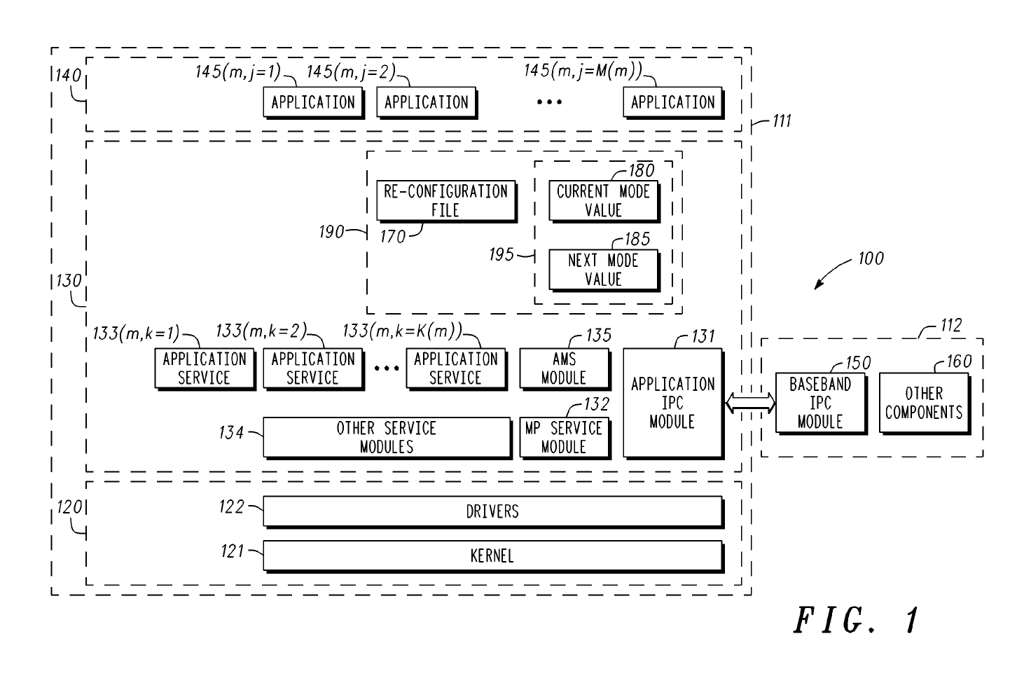

FIG. 1 is a block diagram of a mobile communication device 100 having dual-cores 111,112 as described in various representative embodiments. In particular, FIG. 1 is a block diagram of the software architecture of the dual-core 111,112 device. In FIG. 1, the mobile communication device 100 comprises a first core 111 and a second core 112.

In the representative embodiment of FIG. 1, the second core 112 is baseband processor 112. The baseband processor 112 comprises a baseband inter-processor-communication (IPC) module 150, which may also be referred to herein as a baseband IPC module 150, and other components 160.

Also in the representative embodiment of FIG. 1, the first core 111 is application processor 111. The application processor 111 comprises an operating system 120, an application service layer 130, and an application layer 140. The operating system 120 typically comprises a kernel 121 and one or more drivers 122 which are shown grouped together in FIG. 1. Individually, if the operating system 120 comprises “I” drivers 122, the drivers 122 may be referred to herein as first driver 122a, second driver 122b, . . . , and I-th driver 122I. The application service layer 130 comprises an application inter-processor-communication module 131, a modem proxy (MP) service module 132, various application service modules 133 which will be described in the following, an application management service (AMS) module 135, and a non-volatile persistent memory 190, which may also be referred to herein as a persistent memory 190. The non-volatile persistent memory 190 comprises a re-configuration file 170 and a mode file 195. The mode file 195 comprises a current mode value 180, which may also be referred to herein as a current mode 180, and a next mode value 185, which may also be referred to herein as a next mode 185 and as a target mode 185.

For each mode “m”, the application layer 140 comprises “M” applications 145 to be activated upon a switch to the “m-th” mode. The value for “M” is dependent upon the mode, i.e., M=M(m). Applications for only one mode (the “m-th” mode) are shown in FIG. 1. Those applications are first m-th mode application 145(m,j=1), second m-th mode application 145(m,j=2), . . . , and M(m)-th m-th mode application 145(m,j=M(m)). And also for each mode “m”, the application service layer 130 comprises “K” application service modules 133 to be activated upon a switch to the “m-th” mode. The value for “K” is dependent upon the mode, i.e., K=K(m). Application service modules 133 for only one mode (the “m-th” mode) are shown in FIG. 1. Those application service modules are first m-th mode application service module 133(m,k=1), second m-th mode application service module 133(m,k=2), . . . , and K(M)-th m-th mode application service module 133(m,k=K(M)).

In representative embodiments, the application management service module 135 manages all applications 145 and some application service modules 133 which include launching, monitoring and killing the various applications 145 and the various application service modules 133. The application management service module 135 is capable of determining when and how to change the mobile communication device's 100 operational mode efficiently by reliable synchronization of the application processor 111 and the baseband processor 112. Instructions for re-configuring the mode of the mobile communication device 100 is obtained from the re-configuration file 170 by the application management service module 135 as needed for a mode switch. Software maintenance and upgrades can be simplified by using flexible re-configuration scripts to update the re-configuration file 170. Moreover, the application management service module 135 can be implemented on most popular mobile software systems due to the generic character of the dual-core architecture of the combined application processor 111 and baseband processor 112 of operating systems 120 such as Microsoft Windows Mobile systems, embedded Linux operating systems, and others. The representative embodiments disclosed herein are applicable to most portable or mobile communication devices 100, such as mobile telephones (also referred to as cellular telephones, cellular phones, cell telephones and cell phones), which have dual-core architecture comprising an application processor 111 and a baseband processor 112 regardless of the software operating system 120 found on the application processor 111 side.

The operating system 120 can be any commercially available operating system such as DOS, various versions of Microsoft Windows (Windows 95, 98, Me, 2000, NT, XP, or the like), Apple's MAC OS X, UNIX, Linux, or other suitable operating system. Above the operating system 120 is the application service layer 130, which provides various services to the upper application layer 140. These services could include the calling services, SIM (subscriber identity module) services, global positioning satellite (GPS) services, data services, and the like. The modem proxy service module 132 interacts with the baseband processor 112 and manages all modem services for the application processor 111 applications 145. The application inter-processor-communication module 131 is a general component for providing a data communication path between the application processor 111 and the baseband processor 112. The application management service module 135 is a standalone service and comprises functions of mode switching and general application management. The applications 145 in the application layer 140 are clients of the application service layer 130, are controlled by the application service module 133, and communicate with services through application program interfaces (APIs), messages, events, or other inter-process communication interfaces. The right baseband processor 112 could represent a modem, which provides all the calling and data service functionalities.

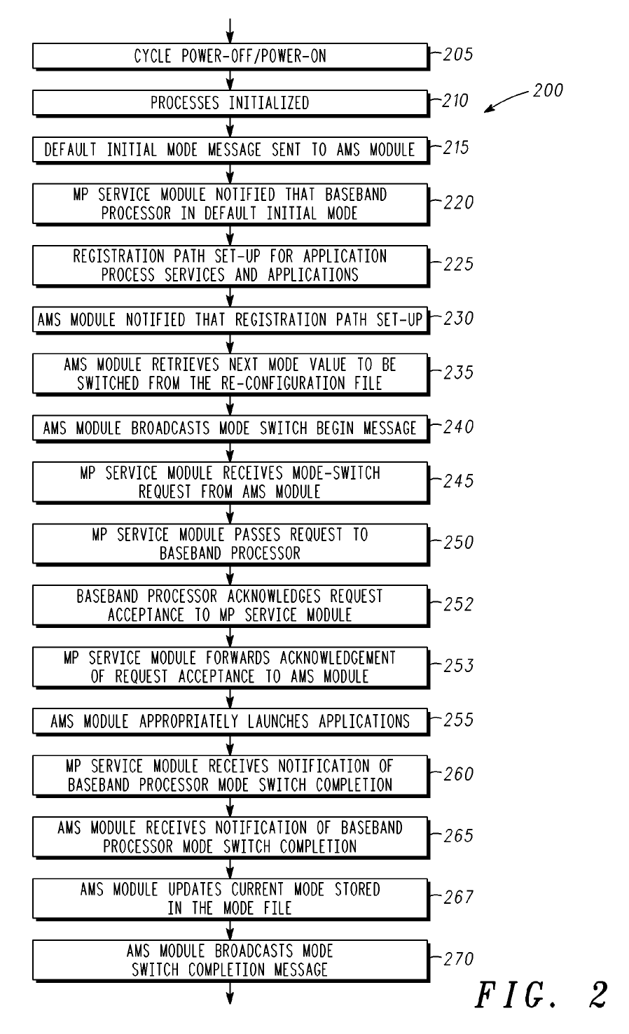

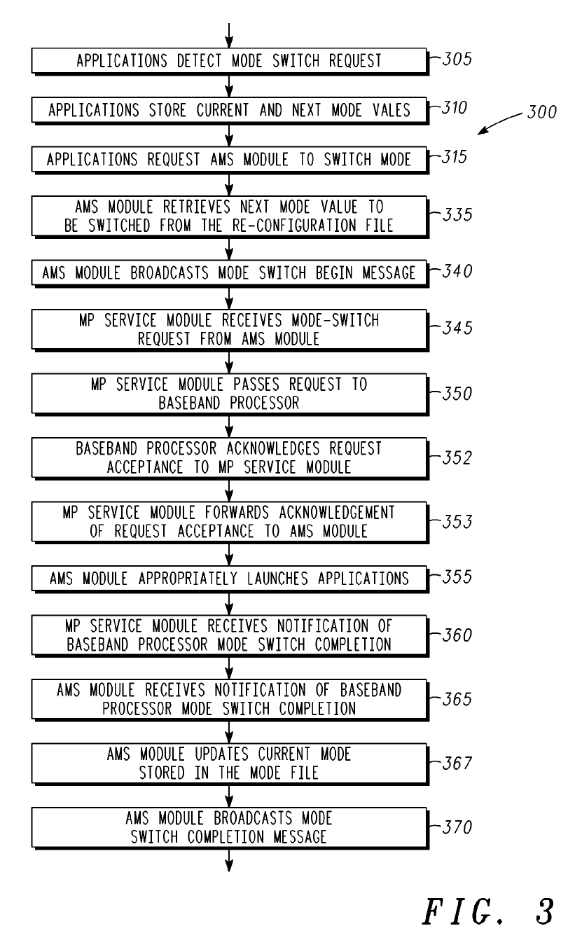

Unlike previous legacy single-core devices, the dual-core mobile communication devices 100 disclosed herein are capable of simplifying and speeding up mode switching. In such devices 100, some but not all operational mode changes must be cycled through the power-off/power-on sequence. Thus, for a first group of operational modes the dual-core mobile communication device 100 is cycled through the power-off/power-on sequence. And, for a second group of operational modes the dual-core mobile communication device 100 is not cycled through the power-off/power-on sequence. In the following discussion, FIG. 2 describes the process of transferring to an operational mode in the first group. And FIG. 3 describes the process of transferring to an operational mode in the second group.

FIG. 2 is a flow chart of a method 200 for mode switching during a power-cycle operation of the mobile communication device 100 of FIG. 1. In block 205, the dual-core mobile communication device 100 is cycled through the power-off/power-on sequence. Block 205 then transfers control to block 210.

In block 210, as a part of the power-up process, both the baseband processor 112 and the application processor 111 perform their initialization processes. Block 210 then transfers control to block 215. Once initialized, the application management service module 135 waits for the baseband processor 112 to provide notification that it has been initialized and is in a default initial mode. In block 215, the application management service module 135 receives a message from the baseband processor 112, via the baseband inter-processor-communication module 150 and the application inter-processor-communication module 131, that it is in the default initial mode. Block 215 then transfers control to block 220.

In block 220, the modem proxy service module 132 is notified by the application management service module 135 that the baseband processor 112 is in the default initial mode. Block 220 then transfers control to block 225.

In block 225, the modem proxy service module 132 sets up a dedicated socket or channel with the baseband processor 112 for all application processor 111 services and applications to register needed modem services from the baseband processor 112. Block 225 then transfers control to block 230.

In block 230, the application management service module 135 receives notification from the modem proxy service module 132 that the dedicated registration path, i.e., the dedicated socket or channel to the baseband processor 112 for all application processor 111 services and applications to register needed modem services from the baseband processor 112, has been generated. Block 230 then transfers control to block 235.

In block 235, the application management service module 135 retrieves the next mode value 185, which may also be referred to herein as the next mode 185, as the target mode 185, as the new operating mode 185, as identification of the new mode 185, and as the new mode identification 185, to be switched to from the mode file 195 in the non-volatile persistent memory 190 of the mobile communication device 100 as shown in FIG. 1 or other appropriate source. The next mode value 185 could have been saved in the mode file 195 during the power-down procedure which was initiated by a mode-switch request. In various representative embodiments, the target mode 185 can be determined in various ways dependent upon the manner in which the command to switch modes was given. These ways include the following: (1) the target mode 185 stored in non-volatile persistent memory during last power off procedure as described above, (2) from bootstrap information, and from (3) codeplug settings. If the target mode 185 is obtained from bootstrap information, special key combinations are entered by the user during power up. For this representative embodiment, a special dedicated key combination is defined that will power up the mobile communication device 100 in a previously selected mode. For example, volume_up_key+power_key together may power up a cell phone 100 into a factory test mode. If the target mode 185 is obtained from codeplug settings, the mobile communication device 100 comprises a pre-configured database called codeplug which includes various configuration settings for the mobile communication device 100. This feature can be used to turn off factory test mode for phones that are ready for shipment. Block 235 then transfers control to block 240.

In block 240, the application management service module 135 broadcasts a “Mode-Switch BEGIN” message to all appropriated components to prepare for the switch. The “appropriate components” include those components that will take part in the mode-switch or that will need to know about it. These components include current active or inactive applications 145 and those application service modules 133 that will need to do a re-initialization or adjustment of their internal configuration upon receiving the “Mode-Switch BEGIN” message. Block 240 then transfers control to block 245.

In block 245, the application management service module 135 sends or conveys a request to switch modes to the modem proxy service module 132. Block 245 then transfers control to block 250.

In block 250, the modem proxy service module 132 passes the request to switch modes to the baseband processor 112 via the application inter-processor-communication module 131. Block 250 then transfers control to block 252.

In block 252, the baseband processor 112 acknowledges acceptance of the request for the mode switch to the modem proxy service module 132. Block 252 then transfers control to block 253.

In block 253, the modem proxy service module 132 forwards acknowledgement of the acceptance of the request for the mode switch to the application management service module 135. Block 253 then transfers control to block 255.

In block 255, the application management service module 135 launches applications 145 according to the target mode 185 as listed in the re-configuration file 170. The format for the re-configuration file 170 is specified by Table 1. Block 255 then transfers control to block 260.

In block 260, the modem proxy service module 132 receives notification from the baseband processor 112 that it has completed the mode switch. Block 260 then transfers control to block 265.

In block 265, the application management service module 135 receives notification from the modem proxy service module 132 that the baseband processor 112 has completed the mode switch. Block 265 then transfers control to block 267.

In block 267, the application management service module 135 updates the current mode value 180 in the mode file 195 or other appropriate location. Block 265 then transfers control to block 270.

In block 270, the application management service module 135 broadcasts a message to all appropriate components that the mode switch has been completed. Those components are now free to proceed with normal functionality. Block 270 then terminates the process.

FIG. 3 is a flow chart of a method 300 for mode switching during normal operation of the mobile communication device 100 of FIG. 1. In block 305, the applications 145 detect the mode switching request which could be by means of a user's input. The user could, for example, request airplane mode via a graphical user interface (GUI). Block 305 then transfers control to block 310.

In block 310, the applications 145 store their current and next mode values 180,185 in the mode file 195 or other appropriate location via the application service modules 133 for use later by the application management service module 135. Block 310 then transfers control to block 315.

In block 315, the applications 145 request that the application management service module 135 switch modes. The mode switching may be accomplished using application program interfaces or by other inter-processor-communication (IPC) techniques. Block 315 then transfers control to block 335.

In block 335, the application management service module 135 retrieves the next mode value 185 to be switched to from the re-configuration file 170 or other appropriate source. Block 335 then transfers control to block 340.

In block 340, the application management service module 135 broadcasts a “Mode-Switch BEGIN” message to all appropriate components to prepare for the switch. The appropriate components include those components that will take part in the mode-switch or that will need to know about it. These components include current active or inactive applications 145 and those application service modules 133 that will need to do a re-initialization or adjustment of their internal configuration upon receiving the “Mode-Switch BEGIN” message. Block 340 then transfers control to block 345.

In block 345, the application management service module 135 sends or conveys a request to switch modes to the modem proxy service module 132. Block 345 then transfers control to block 350.

In block 350, the modem proxy service module 132 passes the request to switch modes to the baseband processor 112 via the application inter-processor-communication module 131. Block 350 then transfers control to block 352.

In block 352, the baseband processor 112 acknowledges acceptance of the request for the mode switch to the modem proxy service module 132. Block 352 then transfers control to block 353.

In block 353, the modem proxy service module 132 forwards acknowledgement of the acceptance of the request for the mode switch to the application management service module 135. Block 353 then transfers control to block 355.

In block 355, the application management service module 135 launches applications 145 according to the target mode as listed in the re-configuration file 170. The format for the re-configuration file 170 is specified by Table 1. Block 355 for the non-power cycle switching case differs from that of block 255 for the power cycle switching case in that since the non-power cycle switching case does not involve power-cycle, the application management service module 135 only needs to identify the components that differ between the current mode and next mode. The application management service module 135 will terminate the unused applications and launch any new applications 145 specified in the re-configuration file 170. A Linux operating system example of the re-configuration file 170 script is found in Table 1. Block 355 then transfers control to block 360.

In block 360, the modem proxy service module 132 receives notification from the baseband processor 112 that it has completed the mode switch. Block 360 then transfers control to block 365.

In block 365, the application management service module 135 receives notification from the modem proxy service module 132 that the baseband processor 112 has completed the mode switch. Block 365 then transfers control to block 367.

In block 367, the application management service module 135 updates the current mode value 180 in the mode file 195 or other appropriate location. Block 365 then transfers control to block 370.

In block 370, the application management service module 135 broadcasts a message to all appropriate components that the mode switch has been completed. Those components are now free to proceed with normal functionality. Block 370 then terminates the process.

TABLE 1
MODE SWITCH RE-CONFIGURATION SCRIPTS

Mode Application/Service List
MODE_1 = A[1, 1]:A[1, 2]: . . . :A[1, M(1)]:S[1, 1]:S[1, 2]
MODE_2 = A[2, 1]:A[2, 2]: . . . :A[2, M(2)]:S[2, 1]
MODE_3 = A[3, 1]:A[3, 2]: . . . :A[3, M(3)]
MODE_4 =
A[4, 1]:A[4, 2]: . . . :A[4, M(4)]:S[4, 1]:S[4, 2]: . . . :S[4, K(4)]
MODE_5 = A[5, 1]:A[5, 2]: . . . :A[5, M(5)]
MODE_6 = A[6, 1]:A[6, 2]:...A[6, M(6)]
MODE_7 = A[7, 1]:A[7, M(7)=2]
MODE_8 = A[8, M(8)=1]
MODE_9 = A[9, 1]:A[9, 2]: . . . :A[9, M(9)]:S[9, 1]
Application/Service Information
(alias : start path : privilege: input parameters :
full executable path)
TASK_A[1, 1] = a[1, 1]::/:::/bin/a[1, 1]
TASK_A[1, 2] = a[1, 2]:/:root::/bin/a[1, 2]
. . .
TASK_A[9, M(9)] = a[9, M(9)]:/::−5:/bin/a[9, M(9)]
TASK_S[1, 1] = s[1, 1]::/:root::/sbin/s[1, 1]
. . .
TASK_S[9, 1] = s[9, 1]::/:usr::/sbin/s[9, 1]

In a representative embodiment for the Linux operating system, Table 1 shows the format of a file or memory storage of the re-configuration information for performing a mode switch in the mobile communication device 100. In Table 1, MODE_{—}1 indicates mode one, MODE_{—}2 indicates mode two, etc. For each mode, Table 1 lists the applications 145 to be activated for that mode and the application service modules 133 to provide services for the applications 145 activated for that mode. Table 1 also lists the tasks to be performed by the applications 145 and application service modules 133 for each mode.

As an example in Table 1 for MODE_{—}2, applications A[2,1], A[2,2], . . . , and A[2,M(2)] are activated. Note that in Table 1, for ease of illustration the first second mode application 145(m=2,j=1) is represented by A[2,1], second second mode application 145(m=2,j=2) is represented by A[2,2], and M(2)-th second mode application 145(m=2,j=(2)) is represented by A[2,M(2)], etc. In general, the j-th m-th mode application 145(m,j) is represented by A[m,j].

Further as an example in Table 1 for MODE_{—}4, application service modules S[4,1], S[4,2], . . . , and S[4,K(4)] are activated. Also in Table 1 for ease of illustration, the first fourth mode application service module 133(m=4,j=1) is represented by S[4,1], second fourth mode application service module 133(m=4,j=2) is represented by S[4,2], and K(4)-th fourth mode application service module 133(m=4,j=M(4)) is represented by S[4,K(4)], etc. In general, the k-th m-th mode application service module 133(m,k) is represented by S[m,k].

Table 1 also lists the alias, start path, privilege, input parameters, and executable path for the applications 145 and application service modules 133 indicated as, for example, TASK_A[1,1] for the first first mode application 145(1,1) or equivalently for the first first mode application A[1,1] and as, for example, TASK_S[9,1] for the first ninth mode application service module 133(9,1) or equivalently for the first ninth mode application service module S[9,1].

As is the case, in many data-processing products, the mobile communication devices 100 described above may be implemented as a combination of hardware and software components. Moreover, the functionality required for use of the representative embodiments may be embodied in computer-readable media (such as floppy disks, conventional hard disks, DVDs, CD-ROMs, Flash ROMs, nonvolatile ROM, and RAM) to be used in programming the mobile communication devices 100 to perform in accordance with the techniques so described.

The term “program storage medium” is broadly defined herein to include any kind of computer memory such as, but not limited to, floppy disks, conventional hard disks, DVDs, CD-ROMs, Flash ROMs, nonvolatile ROM, and RAM.

In a representative embodiment, a method for switching to a new operating mode in a mobile communication device is disclosed. The method comprises retrieving identification of the new mode. The mobile communication device comprises an application processor and a baseband processor; the application processor comprises a modem proxy service module communicatively coupled to the baseband processor and an application management service module communicatively coupled to the modem proxy service module and configured to retrieve identification of a new operating mode, and the application management service module retrieves the identification of the new mode. The method further comprises broadcasting a message from the application management service module to appropriate components in the mobile communication device that directs those components to initiate actions necessary to switch to the new mode, conveying a request from the application management service module to the modem proxy service module and to the baseband processor via the modem proxy service module to switch to the new mode, and switching the application processor to the new mode. The application processor to the new mode comprises launching applications in the application processor by the application management service module. The method still further comprises conveying notification from the baseband processor to the modem proxy service module and to the application management service module via the modem proxy service module that the baseband processor completed the mode switch, updating current mode identification to be that of the new mode identification by the application management service module, and broadcasting notification from the application management service module to all appropriate components that the mode switch has been completed and that those components should proceed with normal functionality.

In another representative embodiment a mobile communication device is disclosed. The mobile communication device comprises a baseband processor and an application processor. The application processor comprises a modem proxy service module communicatively coupled to the baseband processor and an application management service module communicatively coupled to the modem proxy service module and configured to retrieve identification of a new operating mode. The application management service module is configured to broadcast a message to appropriate components in the mobile communication device that directs those components to initiate actions necessary to switch to the new mode, convey a request to the modem proxy service module and to the baseband processor via the modem proxy service module to switch to the new mode, and switch the application processor to the new mode. The switch of the application processor to the new mode comprises the launch of applications in the application processor by the application management service module. The baseband processor is configured to convey notification to the modem proxy service module and to the application management service module via the modem proxy service module that the baseband processor completed the mode switch, And the application management service module is further configured to update a current mode identification to be the new mode identification and broadcast notification to all appropriate components that the mode switch has been completed and that those components should proceed with normal functionality.

In yet another representative embodiment, a means for communicating portably is disclosed. The portable communicating means comprises a means for communicating externally, and a means for executing applications on the portable communicating means. The executing applications means comprises a means for communicating internal with the external communicating means and a means for managing application services communicatively coupled to the internal communicating means and configured to retrieve identification of a new operating mode. The application services managing means is configured to broadcast a message to appropriate components in the portable communicating means that directs those components to initiate actions necessary to switch to the new mode, convey a request to the internal communicating means and to the external communicating means via the internal communicating means to switch to the new mode, and switch the executing applications means to the new mode. The switch of the executing applications means to the new mode comprises the launch of applications in the executing applications means by the application services managing means. The external communicating means is configured to convey notification to the internal communicating means and to the application services managing means via the internal communicating means that the external communicating means completed the mode switch. And the application services managing means is further configured to update a current mode identification to be the new mode identification and broadcast notification to all appropriate components that the mode switch has been completed and that those components should proceed with normal functionality.

The non-power cycle switching case differs from that of the power cycle switching case in that, the application management service module 135 only needs to identify the components that differ between the current mode and next mode for the non-power cycle switching case. The application management service module 135 will terminate the unused applications and launch any new applications 145 specified in the re-configuration file 170. Such mode switching is more efficient in that only those applications 145 that change will need to be terminated or launched. Also, since not all applications 145 need to be active in a dual-core mobile communication device 100, such devices 100 are more efficient in the use of resources.

As described above in representative embodiments, the mobile communication devices 100 do not have to power-cycle every time mode switching is requested. Compared to the legacy mode switching, the present techniques are faster and simpler. In addition, no software re-build and release is needed if there are changes to the available modes in the future. Only the available applications 145 and the script of the re-configuration 170 will need to be changed.

In summery, the application management service module 135 is capable of configuring and switching the operational mode of the mobile communication device 100 reliably through the synchronized interactions of the application processor 111 and the baseband processor 112. Such operational mode switching is faster than the techniques used with legacy mobile telephones and is capable of efficient functioning on dual-core devices 100. The functionality described herein can also be maintained and expanded easily by use of a re-configuration script. Finally, it can be applied in most popular application processor mobile operation systems.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method for switching to a new operating mode in a mobile communication device, comprising:
retrieving identification of the new mode, wherein the mobile communication device comprises an application processor and a baseband processor, wherein the application processor comprises a modem proxy service module communicatively coupled to the baseband processor and an application management service module communicatively coupled to the modem proxy service module and configured to retrieve identification of a new operating mode, and wherein the application management service module retrieves the identification of the new mode;
broadcasting a message from the application management service module to appropriate components in the mobile communication device that directs those components to initiate actions necessary to switch to the new mode;
conveying a request from the application management service module to the modem proxy service module and to the baseband processor via the modem proxy service module to switch to the new mode;
switching the application processor to the new mode, wherein switching the application processor to the new mode comprises launching applications in the application processor by the application management service module;
conveying notification from the baseband processor to the modem proxy service module and to the application management service module via the modem proxy service module that the baseband processor completed the mode switch;
updating current mode identification to be that of the new mode identification by the application management service module; and
broadcasting a message from the application management service module to all appropriate components that the mode switch has been completed.

2. The method as recited in claim 1, wherein identification of the new mode is retrieved from non-volatile persistent memory of the mobile communication device, from a file, from bootstrap information, or from a pre-configured database.

3. The method as recited in claim 1, wherein the appropriate components to which the message directing initiation of actions necessary to switch to the new mode are those components that will take part in the mode-switch or that have a need to know about it.

4. The method as recited in claim 1, wherein the applications launched in switching the application processor to the new mode are specified in non-volatile persistent memory of the mobile communication device, in a file, in bootstrap information, or in a pre-configured database.

5. The method as recited in claim 1, wherein conveying the request to switch modes from the modem proxy service module to the baseband processor is effected via an application inter-processor-communication module.

6. The method as recited in claim 1, further comprising:
conveying acknowledgement of acceptance of the request for the mode switch from the baseband processor to the modem proxy service module and to the application management service module via the modem proxy service module after conveying the command to switch modes from the modem proxy service module to the baseband processor and prior to switching the application processor to the new mode.

7. The method as recited in claim 1, wherein updating of the current mode identification to be the new mode identification is effected in non-volatile persistent memory of the mobile communication device, in a file, in bootstrap information, or in a pre-configured database.

8. The method as recited in claim 1, further comprising:
prior to retrieving identification of the new mode by the application management service module, cycling the mobile communication device through a power-off/power-on sequence, wherein during the power-off/power-on sequence both the baseband processor and the application processor perform their initialization processes;
conveying a message from the baseband processor to the application management service module via the modem proxy service module that the baseband processor is in its default initial mode; and
setting up a communication channel between the modem proxy service module and the baseband processor for all application processor services and applications to register needed modem services from the baseband processor.

9. The method as recited in claim 8, further comprising:
conveying notification from the modem proxy service module to the application management service module that the communication channel is set up once it is set up.

10. The method as recited in claim 1, further comprising:
detecting a request to switch to a new mode by at least one appropriate application prior to retrieving the identification of the new mode by the application management service module;
storing identification of current and new modes by the at least one appropriate application; and
requesting by the at least one appropriate application that the application management service module switches modes.

11. A mobile communication device, comprising:
a baseband processor; and
an application processor, wherein the application processor comprises a modem proxy service module communicatively coupled to the baseband processor and an application management service module communicatively coupled to the modem proxy service module and configured to retrieve identification of a new operating mode, wherein the application management service module is configured to broadcast a message to appropriate components in the mobile communication device that directs those components to initiate actions necessary to switch to the new mode, convey a request to the modem proxy service module and to the baseband processor via the modem proxy service module to switch to the new mode, and switch the application processor to the new mode, wherein the switch of the application processor to the new mode comprises the launch of applications in the application processor by the application management service module, wherein the baseband processor is configured to convey notification to the modem proxy service module and to the application management service module via the modem proxy service module that the baseband processor completed the mode switch, and wherein the application management service module is further configured to update a current mode identification to be the new mode identification and broadcast a message to all appropriate components that the mode switch has been completed.

12. The mobile communication device as recited in claim 11, wherein identification of the new mode is retrieved from non-volatile persistent memory of the mobile communication device, from a file, from bootstrap information, or from a pre-configured database.

13. The mobile communication device as recited in claim 11, wherein the appropriate components to which the message directing initiation of actions necessary to switch to the new mode are those components that will take part in the mode-switch or that have a need to know about it.

14. The mobile communication device as recited in claim 11, wherein in switching to the new mode the application processor is configured to launch applications as specified in non-volatile persistent memory of the mobile communication device, in a file, in bootstrap information, or in a pre-configured database.

15. The mobile communication device as recited in claim 11, wherein the application processor further comprises an application inter-processor-communication module configured to convey the request to switch modes from the modem proxy service module to the baseband processor.

16. The mobile communication device as recited in claim 11, wherein the application management service module is configured to convey acknowledgement of acceptance of the request for the mode switch from the baseband processor to the modem proxy service module and to the application management service module via the modem proxy service module after passing the command to switch modes from the modem proxy service module to the baseband processor and prior to switching the application processor to the new mode.

17. The mobile communication device as recited in claim 11, wherein the application management service module is further configured to update the current mode identification to be the new mode identification in non-volatile persistent memory of the mobile communication device, in a file, in bootstrap information, or in a pre-configured database.

18. The mobile communication device as recited in claim 11, wherein during a power-off/power-on sequence both the baseband processor and the application processor perform their initialization processes, wherein the application management service module is further configured for retrieval of the identification of the new mode to occur after the power-off/power-on sequence, wherein the baseband processor is configured to convey after the power-off/power-on sequence a message to the application management service module via the modem proxy service module that the baseband processor is in its default initial mode, and wherein a communication channel is set up between the modem proxy service module and the baseband processor for all application processor services and applications to register needed modem services from the baseband processor.

19. The mobile communication device as recited in claim 18, wherein the modem proxy service module is configured to convey notification to the application management service module that the communication channel is set up.

20. The mobile communication device as recited in claim 11, wherein the application processor is further configured for retrieval of the identification of the new mode to occur after detection of a request to switch to a new mode by at least one appropriate application in the application processor, wherein the at least one appropriate application is configured to store identification of the current and the new modes after a mode switch, and wherein the at least one appropriate application is configured to request that appropriate application management service modules in the application processor switch modes.

21. A means for communicating portably, comprising:
a means for communicating externally; and
a means for executing applications on the portable communicating means, wherein the executing applications means comprises a means for communicating internal with the external communicating means and a means for managing application services communicatively coupled to the internal communicating means and configured to retrieve identification of a new operating mode, wherein the application services managing means is configured to broadcast a message to appropriate components in the portable communicating means that directs those components to initiate actions necessary to switch to the new mode, convey a request to the internal communicating means and to the external communicating means via the internal communicating means to switch to the new mode, and switch the executing applications means to the new mode, wherein the switch of the executing applications means to the new mode comprises the launch of applications in the executing applications means by the application services managing means, wherein the external communicating means is configured to convey notification to the internal communicating means and to the application services managing means via the internal communicating means that the external communicating means completed the mode switch, and wherein the application services managing means is further configured to update a current mode identification to be the new mode identification and broadcast a message to all appropriate components that the mode switch has been completed.
